(19) United States
(12) Patent Application Publication
(10) Pub. No.: US 2017/0096742 A1
(43) Pub. Date: Apr. 6, 2017

(54) Electrochemical processes for acid whey treatment and reuse

(71) Applicant: Stafford Wheeler Sheehan, Tiverton, RI (US)

(72) Inventor: Stafford Wheeler Sheehan, Tiverton, RI (US)

(73) Assignee: Waste Hub, Bristol, RI (US)

(21) Appl. No.: 15/283,403

(22) Filed: Oct. 2, 2016

Related U.S. Application Data
(60) Provisional application No. 62/236,305, filed on Oct. 2, 2015.

(51) Int. Cl. C25B 13/08; C25B 9/10; C25B 11/04; C02F 1/38; C02F 1/66; C02F 1/00; C02F 1/52; C25B 1/10; C02F 1/467

(52) U.S. Cl. CPC C25B 13/08; C25B 1/10; C25B 9/10; C25B 11/0405; C25B 11/0478; C02F 1/4672; C02F 1/66; C02F 1/001; C02F 1/52; C02F 1/38; C02F 2201/46115; C02F 2103/327

(57) ABSTRACT

Electrochemical devices capable of converting acidic aqueous byproducts of strained yogurt production into value-added materials, as well as methods of making and using these devices, are described herein. Assembly of an electrolytic cell or series of cells that contain an anode that oxidizes organic substances in the aqueous byproduct stream and a cathode that either reduces organic species or water is described. Electrolysis serves to break down the organic matter present in the liquid, such as lactic acid and lactose, as well as aid in the separation of whey protein matter. Gaseous products of this electrolysis process can be either sold or used in waste-to-energy schemes, thereby introducing an environmentally-friendly method for the electrolytic treatment of acid whey.

### CROSS-REFERENCE TO RELATED APPLICATIONS

This application claims the benefit of and priority to U.S. Ser. No. 62/236,305 filed Oct. 2, 2015 and which is incorporated by reference in its entirety.

### STATEMENT REGARDING FEDERALLY SPONSORED RESEARCH OR DEVELOPMENT

Not applicable.

### FIELD OF THE INVENTION

This invention is in the field of electrolytic waste remediation, specifically processes that involve the treatment of acidic byproducts in the dairy industry using electrochemical methods, such as electrolysis.

### BACKGROUND OF THE INVENTION

Dairy products such as milk, yogurt, and cheese are staple foods that represent a large portion of peoples' diets around the world. These products are milk-derived, and encompass a diverse array of foods that are made from condensing, chilling, fermenting, or otherwise treating milk using many different processes. Of these, yogurt is a popular dairy product that is produced by the bacterial fermentation of milk. In the production of yogurt, bacteria known as “yogurt cultures” are added to milk in order to ferment lactose, in turn forming lactic acid which gives yogurt its tart taste and texture. Some types of yogurt are made by straining or otherwise separating yogurt to remove its whey, which results in a yogurt with a thick consistency. This separated yogurt is colloquially referred to as “Greek” yogurt, which has seen a recent increase in both popularity and production.

Greek yogurt generally possesses lower amounts of sugar than other types of yogurt. This is because of the separation process that removes both whey and some of the lactose present in the yogurt. The byproduct of this separation process is an acidic (pH less than 7) liquid that is partly comprised of water, whey, lactose, and lactic acid. The production of Greek yogurt results in roughly two pounds of this byproduct, referred to as “acid whey”, for every pound of Greek yogurt produced. This acid whey is different from sweet whey, which is the whey that is manufactured during the production of hard types of cheese, in that it is more acidic (possesses a lower pH) and contains fewer solids. This makes it more difficult to create a viable, edible product out of this material when compared to sweet whey. The difficulty and cost of disposing this liquid byproduct has led to the development of numerous methods for its remediation using processes such as biodigestion, chemical neutralization (as shown in U.S. Ser. No. 14/138,597), drying (U.S. Ser. No. 13/974,718), and application as an agricultural liquid fertilizer. Dairy producers have also attempted to make new food products out of acid whey, as demonstrated in U.S. Ser. No. 14/893,846 and U.S. Ser. No. 14/253,530. However, few, if any, of these methods are economically beneficial and all have high associated transportation, processing, and/or environmental costs.

Electrolysis is a proven, environmentally-friendly and energy efficient method for removing sediment and organic contaminants from wastewater, having been in use since the mid-twentieth century (U.S. Pat. No. 3,562,137 and U.S. Pat. No. 3,793,173). Electrolytic wastewater treatment uses direct current (DC) electricity between two electrodes, an anode and a cathode, run through a membrane or conductive aqueous medium to separate contaminants into their constituent parts, using electrochemical reactions that take place at the surface of the electrodes. Dimensionally stable anodes have been employed for electrolytic wastewater treatment since its initial discovery, and many different improvements have been developed since then to improve reaction kinetics for different applications (U.S. Pat. No. 6,298,996 and U.S. Pat. No. 6,315,886). The treatment of wastewater using direct electrochemical oxidation with a polymer electrolyte membrane electrolyzer was first shown by Murphy, O. J. et al., Wat. Res. (1992) 26(4):443-451, and since then numerous design iterations have been made, such as are seen in patents U.S. Pat. No. 6,533,919, U.S. Pat. No. 6,328,875, U.S. Pat. No. 9,440,866, and the application U.S. Ser. No. 10/513,037.

In all of these systems, at the anode, water may be oxidized by the donation of electrons from water to the anode, forming either oxygen gas or high-potential free hydroxyl radicals at the surface of an anode which are capable of oxidizing organic matter. Other simultaneous processes, such as electroflotation which continuously removes suspended solids, further purify water in some electrolysis assemblies. While electrochemical technologies such as this are frequently used to remove solids or disinfect water by eliminating harmful bacteria or organic contaminants, it has not to date been proposed or applied to acid whey. Applying electrochemical treatment methods, specifically electrolysis, to remediate acid whey requires further measures, such as an appropriate anode catalyst, pre-filtering, pH control, or a combination of two or more of these. Therefore, invention or reduction of this technique to practice in the case of acid whey is neither straightforward nor obvious.

### SUMMARY OF THE INVENTION

Electrochemical devices, systems, and methods for the processing of acid whey, in order to reduce its disposal or remediation cost, are described herein. “Electrochemical devices” include, but are not limited to, an electrochemical cell that is comprised of electrodes submerged directly into either a solution of acid whey, pre-filtered acid whey, a solution that comes into contact with acid whey, or a membrane that is in contact with acid whey. In these devices, the negative electrode from which electrons flow into an external circuit is denoted the anode, and the positive electrode into which electrons are fed is the cathode. The anode and cathode are not always the same material, and in many cases are comprised of different elements and architectures. The anode and cathode may be switched by reversing the polarity of the current flowing through the system, as is controlled by a DC power source. This is in some cases performed in order to clean electrodes or prevent the buildup of proteins or other materials that can hinder operation of the device.

In some embodiments, a membrane is used to separate the chambers in which the anode and cathode are kept. The membrane may be a monopolar material, such as Nafion, a size-selective semi-permeable membrane, a bipolar membrane that equalizes the concentration of protons on either side of the membrane, or any number of membrane technologies that are used to separate anolyte and catholyte. In some embodiments, the anode and cathode will be directly deposited on either side of the membrane to form a “membrane electrode assembly”, which is abbreviated “MEA”. In other cases, the anode and cathode will be free-standing and not connected or adhered directly to a membrane, in which case they are denoted “dimensionally stable electrodes”. These modular assemblies which always possess an anode and a cathode, and in some cases possess a membrane, are denoted as an “electrochemical cell”. A wastewater electrolysis device that processes acid whey, as is the object of this invention, will typically be comprised of multiple electrochemical cells in series or in parallel.

This invention uses electrochemical cells in order to oxidize or otherwise remove lactose, lactic acid, proteins, and other organic matter from acid whey. In some cases, the acid whey will be pre-filtered by a filtration, ultrafiltration, flocculation, settling, or any other system or systems before it is introduced into the electrochemical cell. Once introduced into the electrochemical cell, in some embodiments, this organic matter is oxidized by hydroxyl radicals generated at the surface of the anode. In some other embodiments, this organic matter is oxidized by a catalyst on the surface of the anode. The products of this oxidation reaction include, but are not limited to, carbon dioxide, oxygen, carbon monoxide, nitrous oxide, pyruvic acid, acetic acid, among others. On the cathode, in some embodiments, water is reduced to produce hydrogen gas. The anode is always in contact with the acid whey stream, however in some embodiments the cathode may be separated from the feed stream by the membrane, as is typical in a polymer electrolyte membrane electrolyzer.

It is another object of this invention to provide the methods by which a water stream of higher purity than the input whey byproduct stream can be derived from this electrolytic treatment. In some embodiments, the water stream is partially or fully purified of organic contaminants. The water stream may in some cases be neutral (pH near 7). Derivation of this water stream may be performed using one or more techniques that are known to those skilled in the art, including but not limited to incorporating a semipermeable membrane that maintains an acidic pH in the anode chamber while allowing the cathode chamber to neutralize or basify, use of a bipolar membrane assembly wherein neutral water is derived from an assembly that includes one or more anion selective layers and cation selective layers, by periodic removal of acidic equivalents from the anode chamber, or combinations thereof.

One advantage of treating liquid acid whey in this manner is that it is possible to separate out aqueous contaminants as gases by electrochemically oxidizing organic species into carbon dioxide. Additionally, solids remaining in the solution after filtration and/or flocculation may be removed by flotation on the gas bubbles generated by the oxidation of the aqueous species. Furthermore, another advantage is that the transportation cost of the material is lessened, since this treatment is modular and can be performed on-site.

### BRIEF DESCRIPTION OF THE DRAWINGS

FIG. 1 shows a schematic of one embodiment of the system. Acid whey is fed from a holding silo (1) using a pump (2) into an ultrafiltration system (3), which filters out whey proteins. The wet whey proteins are further concentrated using a screw press (4). The remaining filtered acid whey is fed via a flow plate (5) to an anode chamber (6) that contacts the anode (7) on the surface of a membrane (8) that are part of a membrane electrode assembly. At the anode, the dissolved organics in the filtered acid whey stream are oxidized into carbon dioxide, protons (that are transported across the membrane), and electrons (that are transported to the cathode via the external circuit). Reduction of protons transported across the membrane occurs at the cathode (9) on the opposite side of the membrane electrode assembly, and hydrogen gas is generated in the cathode chamber (10). A feedback loop with a variable-speed peristaltic pump (11) allows for multiple passes of the filtered acid whey through the electrolysis system for further treatment of the stream, and a DC power source (12) is connected between the anode and cathode to supply electrical energy.

FIG. 2 shows cyclic voltammograms (CVs) of an antimony-doped tin oxide (ATO) anode immersed in a solution of acid whey both with and without an appropriate catalyst, demonstrating catalytic oxidation of the acid whey organic matter into carbon dioxide and concomitant evolution of hydrogen gas at a platinum cathode, at moderate potentials which enables high efficiency.

### DETAILED DESCRIPTION OF THE INVENTION

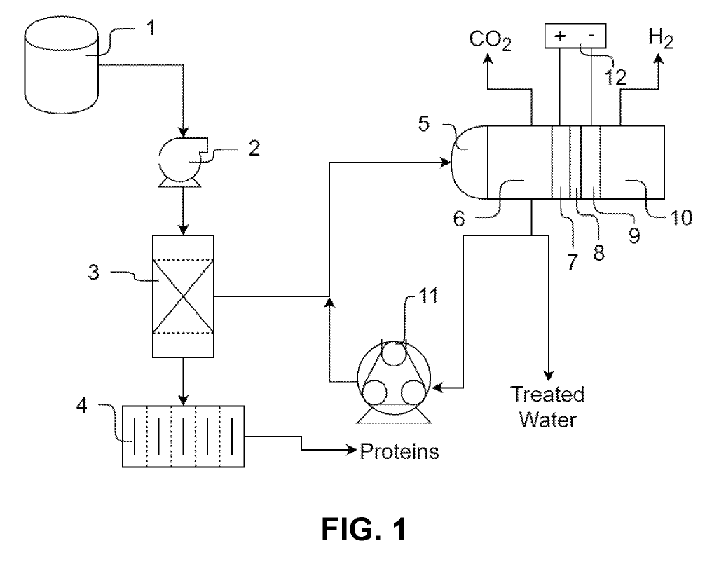

Acid whey is typically produced on the scale of thousands of gallons per day. This requires a system that is able to operate using large volumes. The acid whey first is pumped or otherwise flows into a filtration system wherein protein-based solids are removed from the stream using a process or processes that include, but are not limited to, ultrafiltration, filtration, flocculation, electroflocculation, screening, centrifugation, and/or settling system, in order to prevent electrode or membrane fouling by the whey solids. The resulting stream possesses a lower percentage of solids, and is fed into the electrochemical device which is comprised of an anode and cathode, in some embodiments separated by a membrane. A schematic depicting an example of this process is shown in FIG. 1.

The electrochemical device, specifically an electrolysis system that is an object of this invention, contains an anode and cathode. Upon application of an electric potential from a DC electrical source including, but not limited to, a rectifier, battery, or solar panels, electrochemical reactions take place on the surface of the anode and cathode. In some embodiments, these electrochemical reactions result in the generation of carbon dioxide gas from the oxidation of organic matter at the surface of the anode, while hydrogen gas is generated by the reduction of water at the cathode. Furthermore, in some embodiments gas bubbles generated may serve to float any remaining whey solids to the surface of the anode and/or cathode chamber, where they can then be collected. Additionally, in other embodiments these electrochemical reactions oxidize organic contaminants, water, and other substrates in the water to form a mixture of inert gases that include, but are not limited to, oxygen, carbon dioxide, and nitrogen.

Since the majority of the acid whey stream is water, in some embodiments of the present invention the highest percent by weight output will also be water. In some cases, the electrochemical device serves to neutralize the water by removing acid equivalents using a pH gradient across a cation exchange membrane, bipolar membrane, or other technology known to those skilled in the art. In some others, the water output stream may also have a lower concentration of organic contaminants due to oxidation during the electrolysis process.

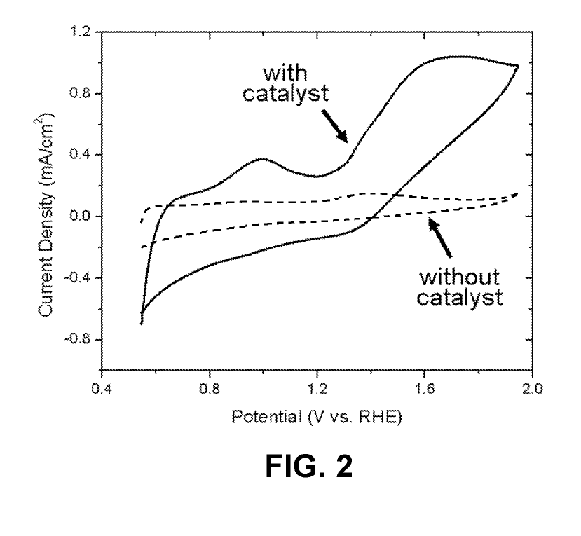

In some embodiments, a catalyst is present on the surface of the anode to facilitate oxidation of organic matter. FIG. 2 shows the effect of a precious metal catalyst on an antimony-doped tin oxide anode using cyclic voltammograms to electrochemically probe the system. Catalytic currents shown in the cyclic voltammograms are proportional to rates of reaction for the oxidation of hydrocarbons, such as lactic acid, to carbon dioxide, and can be significantly increased with the presence of a catalyst. Sampling of the gas output streams demonstrate that the faradaic efficiency of this reaction is at least 0.5%, 1%, 5%, 10%, 20%, 40%, 60%, 80%, 90%, 95%, 98%, 99%, 99.5%, 99.9%, or higher with the presence of a suitable catalyst. “Faradaic efficiency”, in the manner it is used herein, refers to the coulombic efficiency of the system. This is a ratio of the theoretical maximum amount of carbon dioxide produced as calculated from the measured current flow, assuming four electrons are withdrawn from each lactic acid molecule per molecule of carbon dioxide produced, with the amount of carbon dioxide measured that is evolved from the anode. “Catalyst” includes, but is not limited to, iridium oxides, molecular heterogeneous iridium species, iridium-based species, platinum metal or platinum-based species, cobalt metal or cobalt-based species, manganese metal or manganese-based species such as manganese oxide, iron or iron-based species, or any combination of the aforementioned materials in alloys, mixed metal oxides, molecular species, or the like. In most cases, these catalysts selected for this process are capable of oxidizing the organic material in acid whey, including lactic acid and lactose, into carbon dioxide.

In some embodiments, hydrogen generated at the surface of the cathode due to water reduction can be fed into a hydrogen fuel cell system to recapture some of the energy required to oxidize the organic material in the acid whey stream. This reaction has the potential to be thermodynamically downhill, since the hydrogen gas is generated by oxidation of hydrocarbons (an electrochemical reaction possessing a reversible potential lower than 1.23 V), then combined in a fuel cell to produce water (an electrochemical reaction possessing a reversible potential of 1.23 V). Furthermore, in some embodiments, carbon dioxide that is generated electrochemically at the surface of the anode can be purified, compressed, solidified, and/or liquefied and sold as a product.

Unless defined otherwise, all technical and scientific terms used herein have the same meanings as commonly understood by one of skill in the art to which the disclosed invention belongs. Those skilled in the art will recognize, or be able to ascertain using no more than routine experimentation, many equivalents to the specific embodiments of the invention described herein. Such equivalents are intended to be encompassed by the following claims.

I claim:

1. A method for treating the acidic whey byproduct of strained yogurt production using electrolysis, wherein the method comprises:
flowing the liquid byproduct into an electrolytic cell, wherein organic matter in the byproduct is oxidized at an anode
applying a voltage between an anode and cathode to provide a driving force for he electrolytic oxidation reactions at the anode
discharge of treated wastewater that possesses a lower concentration of organic material than the input acid whey byproduct

2. The method of claim 1, wherein the treated wastewater discharge has a pH higher than the acid whey byproduct

3. The method of claim 2, wherein the treated wastewater is of a pH between 5 and 8.

4. The method of claim 1, wherein a membrane is present between the anode and cathode.

5. The method of claim 4, wherein the membrane is a polymer electrolyte membrane.

6. The method of claim 5, wherein the membrane is part of a membrane electrode assembly (MEA).

7. The method of claim 6, wherein the MEA is housed in a polymer electrolyte membrane electrolyzer.

8. The method of claim 1, wherein a catalyst is adhered to the surface of the anode in order to facilitate oxidation and/or prevent fouling.

9. The method of claim 8, wherein the catalyst is a carbon-based material.

10. The method of claim 8, wherein the catalyst contains a transition metal element.

11. The method of claim 10, wherein the catalyst is an iridium-containing material.

12. The method of claim 1, wherein a filtration, flocculation, screening, centrifugation, and/or settling system is used on the acidic whey byproduct prior to flowing into the electrolytic cell, in order to prevent electrode or membrane fouling.

13. The method of claim 1, wherein gaseous products are evolved at the anode and/or cathode.
